(19) United States
(12) Patent Application Publication
(10) Pub. No.: US 2015/0221020 A1
(43) Pub. Date: Aug. 6, 2015

(54) METHOD AND SYSTEM FOR MANAGING A SHOPPING LIST

(71) Applicant: NCR Corporation, Duluth, GA (US)

(72) Inventors: Erick C. Kobres, Lawrenceville, GA (US); John Bruno, Mahwah, NJ (US)

(21) Appl. No.: 14/609,982

(22) Filed: Jan. 30, 2015

Related U.S. Application Data
(60) Provisional application No. 61/934,330, filed on Jan. 31, 2014.

(51) Int. Cl. G06Q 30/06; G06Q 30/02

(52) U.S. Cl. CPC G06Q 30/0635; G06Q 30/0631; G06Q 30/0253

(57) ABSTRACT

A method and system whereby a list of items is stored, the stored list of items is compared to actual items scanned at a terminal, and a visual indication of a correspondence or lack of correspondence between the stored list of items and the actual items scanned at the terminal is provided to a customer.

### FIELD OF THE INVENTION

The present invention relates to a system and method for managing a shopping list. More particularly, the present invention relates to a system and method that assists a customer in reconciling a shopping list at check-out by comparing the items in the shopping list to actual items being purchased.

### BACKGROUND OF THE INVENTION

There is an increasing need to have customers use automated self-service check-out terminals for transactions in retail stores, supermarkets, etc. In addition, developments are being made to use high-velocity scanning systems, such as those described in U.S. patent application Ser. No. 13/874,097, the entire contents of which are incorporated herein by reference as if fully set forth.

With these high-velocity scanning systems, a customer will typically want to be provided with assurances that his/her products are properly accounted for during the check-out process. In order to keep track of the products scanned in such systems, it is likely that customers will interrupt the high-velocity scanning system to verify that the items they are purchasing are actually scanned properly. However, having a customer interrupt such systems defeats the purpose of the high-velocity system. Thus, there is a need for a mechanism where customers can verify transaction details without slowing down or interrupting such high-velocity systems.

### SUMMARY OF THE INVENTION

The present disclosure provides for a method and system whereby a list of items is stored, the stored list of items is compared to actual items scanned at a terminal, and a visual indication of a correspondence or lack of correspondence between the stored list of items and the actual items scanned at the terminal is provided to the customer.

In a further embodiment, the actual items scanned at the terminal are analyzed and a message is displayed relating to the analysis of the actual scanned items. The message can be a promotional offer or coupon for an item that is not one of the actual scanned items, or it can be a suggestion to purchase an item that is related to one of the actual scanned items.

In still a further embodiment, the stored list of items is analyzed and a message is displayed relating to the analysis of the stored list of items. The message can be a promotional offer or coupon for an item that is not in the stored list of items, or it can be a suggestion to purchase an item that is related to an item in the stored list of items.

### BRIEF DESCRIPTION OF THE DRAWINGS

The present invention may take form in various components and arrangement of components and in various methods. The drawings are only for purposes of illustrating example embodiments and alternatives and are not to be construed as limiting the invention. The drawings are not necessarily drawn to scale. Throughout the drawings, like reference numerals are used to represent like elements.

FIG. 1 is a general system diagram of an embodiment of the present invention.

FIG. 2 is a flowchart showing an embodiment for creating a shopping list.

FIG. 3 shows an embodiment of a shopping list displayed on a mobile device.

FIG. 4 shows an embodiment of a promotional offer and coupon displayed on a mobile device.

FIG. 5 shows an embodiment where the promotional item and coupon have been added to the shopping list and displayed on a mobile device.

FIG. 6 shows an embodiment of a suggestion for an additional item displayed on a mobile device.

FIG. 7 shows an embodiment where the additional item and has been added to the shopping list and displayed on a mobile device.

FIG. 8 is a flowchart showing an embodiment for reconciling the shopping list with actual scanned items.

FIG. 9 shows an embodiment of a reconciled shopping list as displayed on a mobile device.

### DETAILED DESCRIPTION OF THE PREFERRED EMBODIMENTS

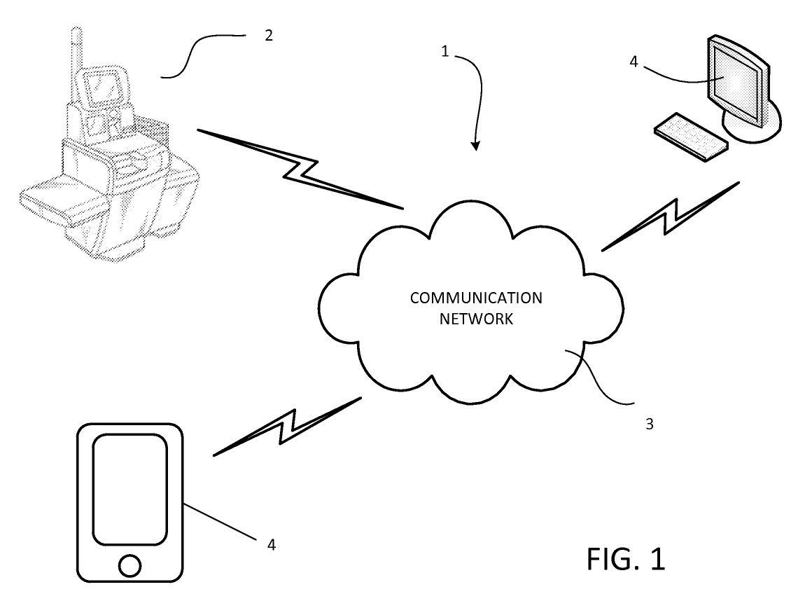

Referring now to the drawings, FIG. 1 shows a diagram of a system 1 for managing a shopping list. The basic components of the system 1 include an item scanning terminal 2 linked to a communication network 3, and one or more customer devices 4 linked to the communication network. The customer devices can be a mobile device such as a smartphone or tablet computer, or a personal computer. Each of the customer devices preferably includes hardware and software for communicating with the communications network 3, and for creating a shopping list (described in more detail below).

The following description makes specific reference to the present invention as implemented in a grocery shopping environment wherein the item scanning terminal 2 is configured to scan supermarket store items. It will be readily apparent to one of skill in the art that the present invention is not limited to this implementation and can be easily modified for use in conjunction with other retail store environments, and the like.

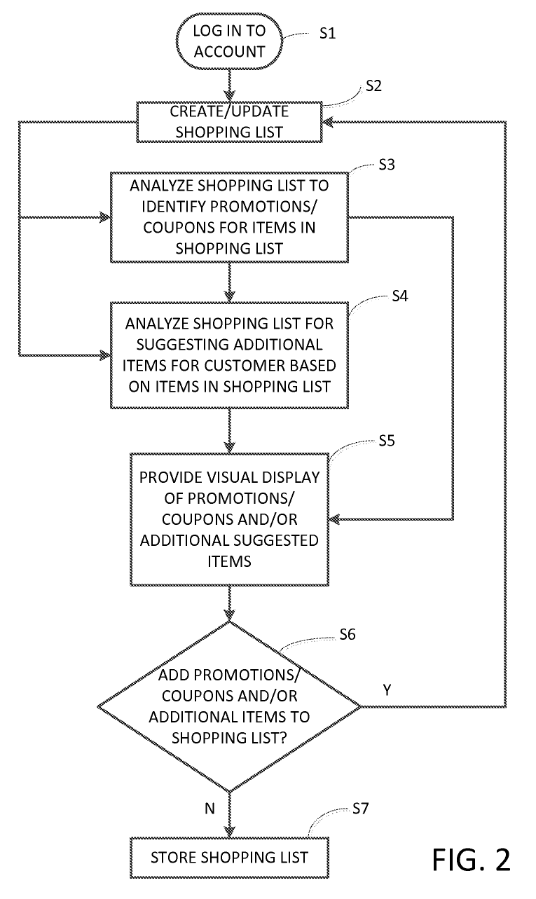

Referring now to FIGS. 2-7, the steps for creating a shopping list will be described. As shown in FIG. 2, the customer devices 4 are configured to create and display thereon a shopping list 5. This is preferably accomplished through the use of application software if the customer device 4 is a smartphone or tablet device, or through the use of a website if the customer device 4 is a personal computer. To create the shopping list 5, the customer will preferably use the application software or website to log in to an account associated with the store where they intend to purchase the items (Step S1 in FIG. 2).

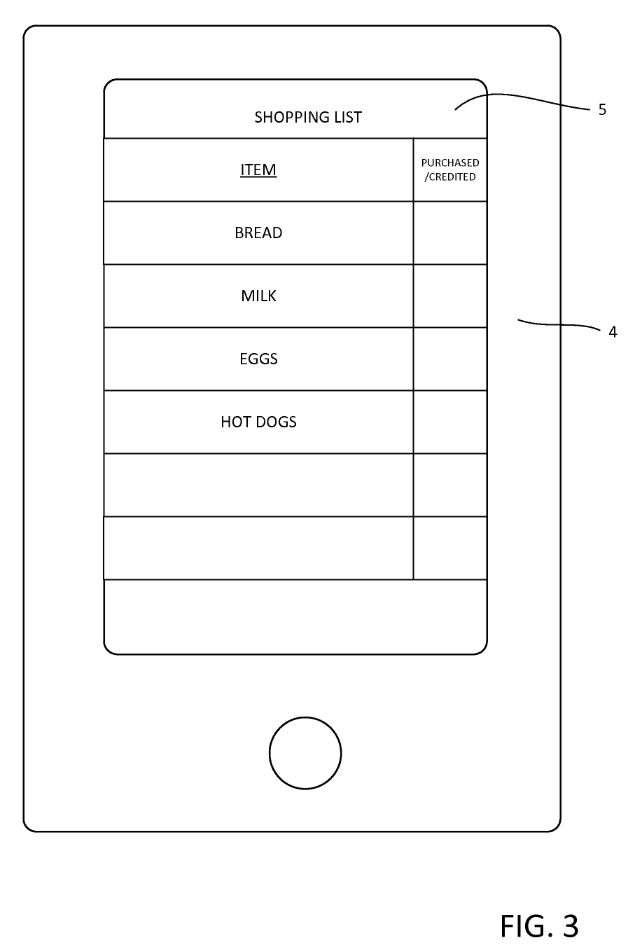

Next, at step S2, the customer will add items to the shopping list 5. The addition of items to the shopping list can be accomplished in a number of ways. For example, the application software or website can have access to a database containing a multitude of items available at a store for purchase. This database can be resident on the customer device or it can be maintained within the communications network 3. Such a database can also have coupons or promotions stored therein that can be added by the customer to the shopping list. In addition, the customer device itself can be provided with software and hardware capable of scanning items or coupons as a way of adding them to the shopping list. As shown in the exemplary embodiment of FIG. 3, the customer has added bread, milk, eggs and hot dogs to the shopping list 5.

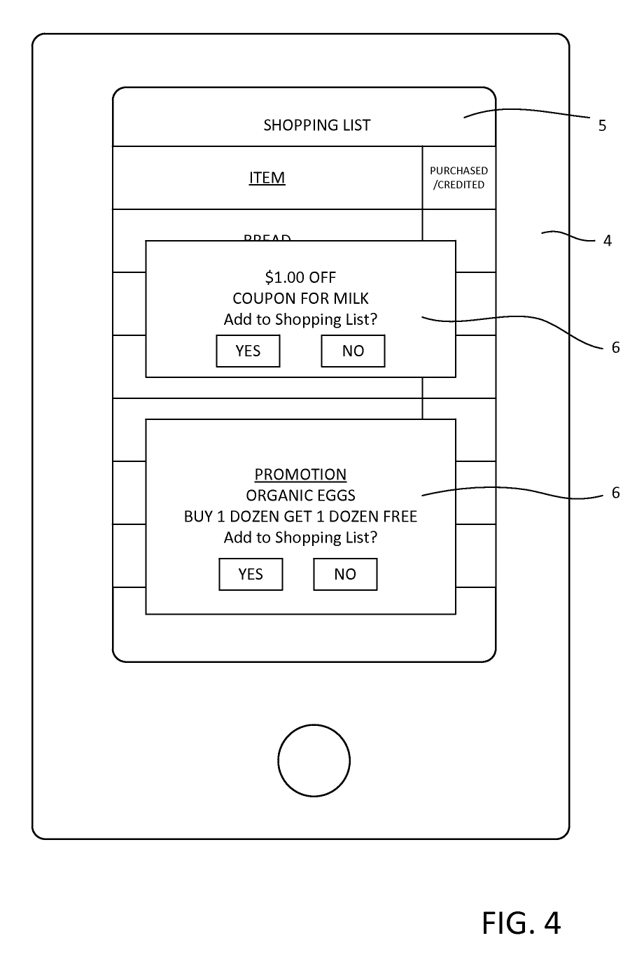

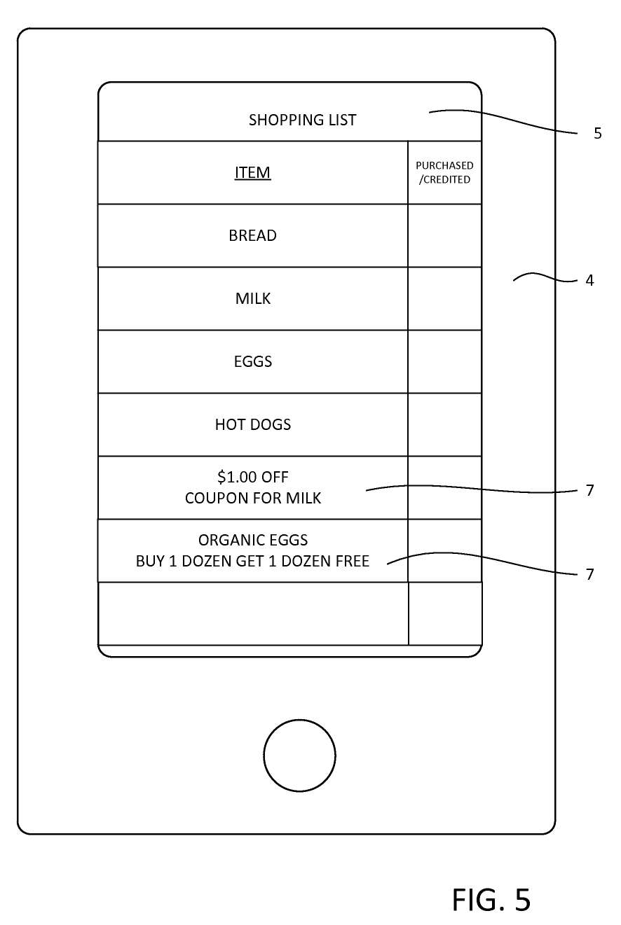

After the items are added, the application software or website can analyze the items to identify if there are any promotions or coupons available for the items in the shopping list that the customer has not included (Step S3). This can be accomplished by having the aforementioned database contain a cross-reference to promotions or coupons relating to the items in the shopping list. When analyzing the shopping list, the application software or website checks the database for any cross-referenced promotions or coupons that are not included in the shopping list and related to items in the shopping list. Thereafter, the application software or website is further programmed to output a visual indication 6 on the customer device 4 of any promotions or coupons available for the items in the shopping list (Step S5). This visual indication 6 can take the form of a “pop-up window” such as that shown in FIG. 4, or can just be an automatic entry 7 into the shopping list 5 as shown in FIG. 5. If the visual indication 6 is in the form of a “pop-up window” as shown in FIG. 4, it is preferred that the customer have an opportunity to add or not add the promotion or coupon to the shopping list in step S6. If the customer indicates that he or she would like to add the promotion or coupon to the shopping list 5, then process returns to step S2 in FIG. 2, the shopping list 5 is updated to add the promotion or coupon as shown in FIG. 5, and the steps in FIG. 2 are then repeated until the customer indicates that the list is complete and should be stored in step S7.

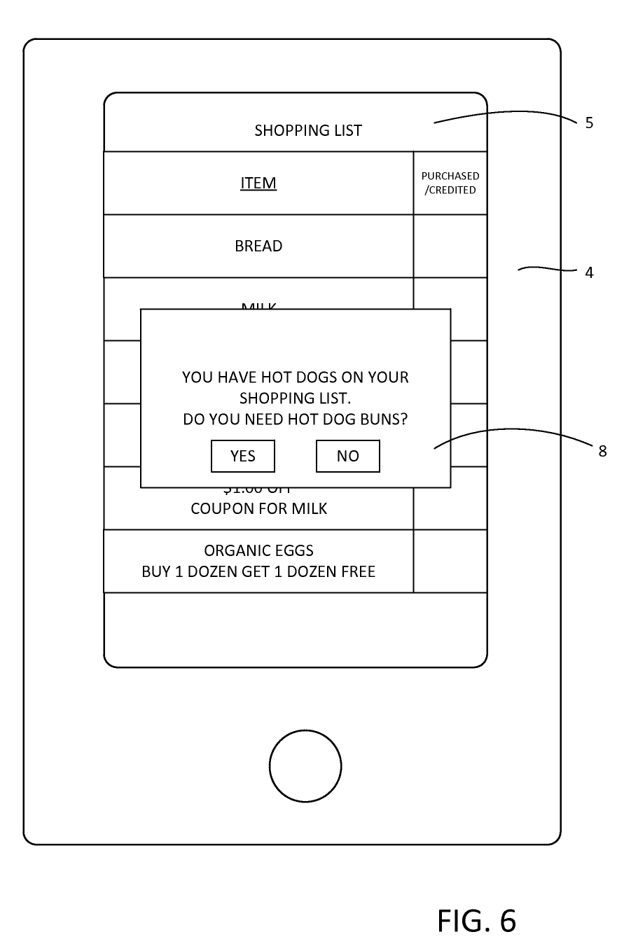

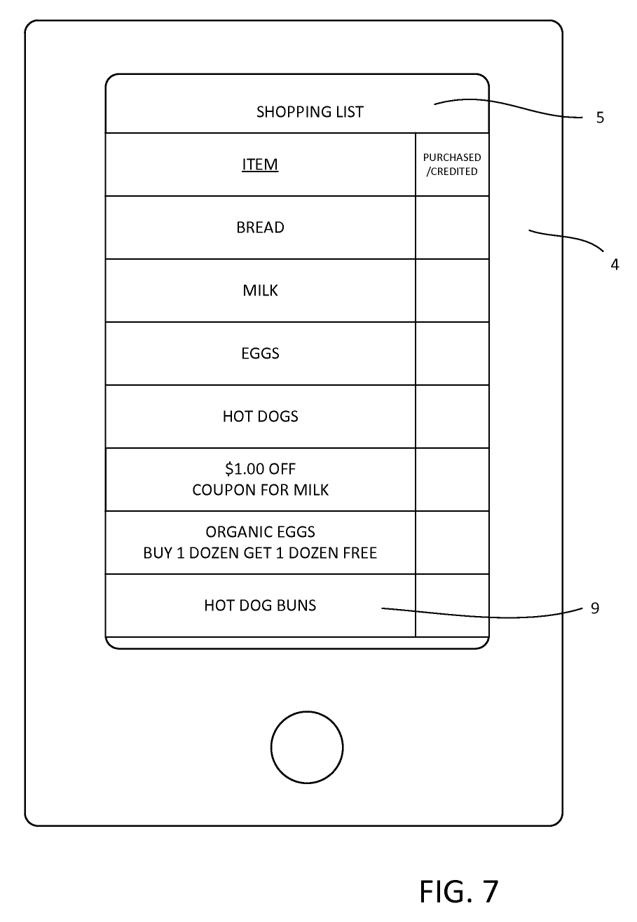

In addition to, or instead of step S3, the application software or website can analyze the items in the shopping list 5 to suggest additional items that the customer may have omitted (step S4). This can be accomplished by having the aforementioned database contain a cross-reference to items that relate to the items in the shopping list. For example, FIG. 3 shows that the customer has added hot dogs to the shopping list. When analyzing the shopping list, the application software or website checks the database for any cross-referenced items that are not included in the shopping list and provides an alert to the customer that it may be desirable to include, for example, hot dog buns on the shopping list. Thereafter, the application software or website is further programmed to output a visual indication 8 on the customer device 4 of any additional items that the customer may be interested in purchasing (Step S5). Similar to the promotion/coupon visual indication, the visual indication 8 for additional items preferably takes the form of a “pop-up window” such as that shown in FIG. 6. It is also preferred that the customer have an opportunity to add or not add the suggested item to the shopping list in step S6. If the customer indicates that he or she would like to add the suggested item to the shopping list 5, then process returns to step S2 in FIG. 2, the shopping list 5 is updated to add the suggested item 9 as shown in FIG. 7, and the steps in FIG. 2 are then repeated until the customer indicates that the list is complete and should be stored in step S7.

It should be noted that if the customer uses a personal computer and associated website, then the stored shopping list is preferably made available in application software for a mobile device. With this, the customer can log in to his/her account on the mobile device and have the shopping list available when they travel to the store to purchase the items.

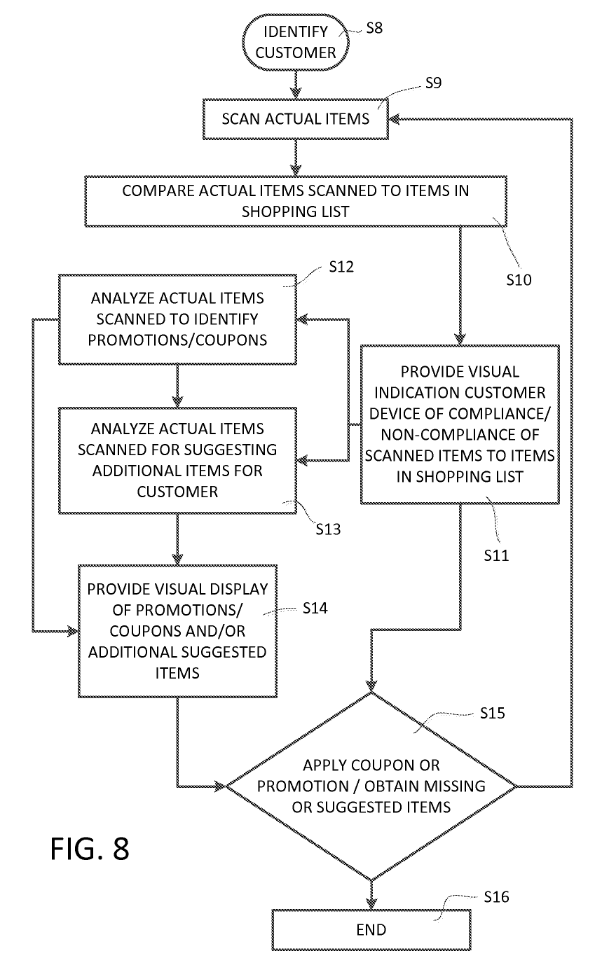

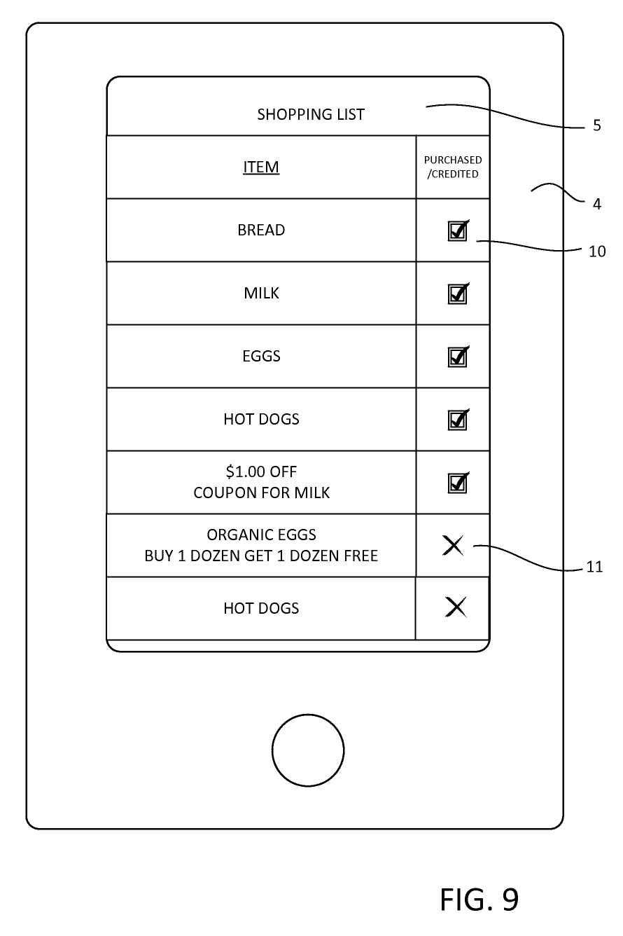

FIGS. 8 and 9 show the steps carried out when the customer is purchasing the items in a store. In step S8 of FIG. 8, when the customer arrives at the check-out terminal 2 (FIG. 1), the customer is identified. This can be accomplished by scanning a customer's membership card or otherwise entering a customer identification number at the terminal 2. After the customer is identified at step S8, the items being purchased by the customer are scanned at the terminal 2 (step S9). As noted above, the terminal 2 can be a standard, manual point-of-sale (POS) scanning system, or it can be a high-velocity scanning system.

After the items are scanned in step S9, information regarding the actual scanned items is communicated from the terminal 2 to the communication network 3. Next, at step S10, the actual scanned items are compared to the items contained in the customer's shopping list 5. As one of skill in the art will appreciate, this comparison can be accomplished within the communication network 3 itself, and the results pushed to the customer device 4. For example, the comparison can be carried out in a cloud-computing environment within the network 3. Alternatively, the data regarding the actual scanned items can be sent to the customer device 4, and the comparison can be carried out on the customer device 4 itself.

Once the comparison is completed, a visual indication is provided on the customer device 4 showing compliance or non-compliance of the actual scanned items to those of the customer's shopping list 5 (step S11). As shown in FIG. 9, this visual indication can be in the form of a “check” 10 which indicates that the actual scanned item matches an item in the shopping list, or an “X” 11 which indicates that an item is missing from the scanned items or does not match a scanned item. As one of skill in the art would understand from the instant disclosure, this visual indication can also be in the form of a “pop-up window” similar to that shown in FIGS. 4 and 6. By providing this easily recognizable visual indication of compliance/non-compliance, a customer can easily determine if the shopping list matches with the items actually purchased.

Similar to the analysis of the items in the shopping list at step S3 in FIG. 2, the terminal or the computing arrangement in the communication network 3 can also be programmed to analyze the actual scanned items to identify if there are any promotions or coupons available therefor (step S12 of FIG. 8). A visual indication of these possible promotions or coupons can then be provided to the customer on a display of the terminal 2 itself, or they can be pushed to the customer device 4 and displayed thereon (step S14). Such an analysis of the actual scanned items will allow the customer to take advantage of promotions or coupons for items that the customer decided to purchase in the store or substituted for an item in the shopping list. At step S15, the promotion or coupon can be applied to the customer purchase.

In addition to, or instead of step S12 (and similar to the analysis of the items in the shopping list at step S4 in FIG. 2), the terminal or the computing arrangement in the communication network 3 can also be programmed to analyze the actual scanned items to suggest additional items that the customer may have omitted (step S13). A visual indication of these additional suggested items can then be provided to the customer on a display of the terminal 2 itself, or they can be pushed to the customer device 4 and displayed thereon (step S14).

After the visual indications are provided in steps S11 and S14, the customer is given the opportunity to obtain the missing or suggested items for purchase (step S15). If the customer decides to obtain the missing or suggested items, then the process repeats at step S9 for the missing or suggested items. If the customer decides not to obtain the missing or suggested items, then the transaction is completed and the process ends at step S16.

While the foregoing description and drawings represent an illustrative embodiment of the present invention, it will be understood that various additions, modifications, and substitutions may be made therein without departing from the spirit and scope of the present invention as defined in the accompanying claims. Therefore, the present invention is not limited to only the embodiments specifically described herein. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. The presently disclosed embodiment is therefore to be considered in all respects as illustrative and not restrictive, the scope of the invention being indicated by the appended claims, and not limited to the foregoing description.

What is claimed is:

1. A method of reconciling a shopping list, the method comprising:
accessing a stored list of items;
comparing the stored list of items to actual items scanned at a terminal;
providing a visual indication of a correspondence or lack of correspondence between the stored list of items and the actual items scanned at the terminal.

2. The method according to claim 1, further comprising:
analyzing the actual items scanned at the terminal; and
displaying a message relating to the analysis of the actual scanned items.

3. The method according to claim 2, wherein the message is a suggestion to purchase an item that is not one of the actual scanned items.

4. The method according to claim 2, wherein the message is a promotional offer or coupon for an item that is one of the actual scanned items.

5. The method according to claim 1, further comprising:
analyzing the stored list of items; and
displaying a message relating to the analysis of the stored list of items.

6. The method according to claim 5, wherein the message is a suggestion to purchase an item that is not one of the actual scanned items.

7. The method according to claim 5, wherein the message is a promotional offer or coupon for an item that is in the stored list of items.

8. The method according to claim 1, wherein the list of items is stored in a memory of mobile device.

9. The method according to claim 8, wherein the visual indication is provided on a display of the mobile device.

10. A method of reconciling a shopping list, the method comprising:
scanning items at a terminal;
comparing the scanned items to a stored list of items;
providing an indication of a correspondence or lack of correspondence between the stored list of items and the items scanned at the terminal.

11. The method according to claim 10, further comprising:
analyzing the items scanned at the terminal; and
transmitting a message relating to the analysis of the actual scanned items.

12. The method according to claim 11, wherein the message is a suggestion to purchase an item that is not one of the actual scanned items.

13. The method according to claim 11, wherein the message is a promotional offer or coupon for an item that is one of the actual scanned items.

14. The method according to claim 10, further comprising:
analyzing the stored list of items; and
transmitting a message relating to the analysis of the stored list of items.

15. The method according to claim 14, wherein the message is a suggestion to purchase an item that is not one of the actual scanned items.

16. The method according to claim 14, wherein the message is a promotional offer or coupon for an item that is in the stored list of items.

17. A system comprising:
a memory configured to store a list of items; and
a processor containing software for reconciling a shopping list by:
comparing the stored list of items to actual items scanned at a terminal; and
providing an indication of a correspondence or lack of correspondence between the stored list of items and the actual items scanned at the terminal.

18. The system according to claim 17, wherein the processor further:
analyzes the actual items scanned at the terminal; and
creates a message relating to the analysis of the actual scanned items.

19. The system according to claim 18, wherein the message is a suggestion to purchase an item that is not one of the actual scanned items.

20. The system according to claim 18, wherein the message is a promotional offer or coupon for an item that is one of the actual scanned items.

21. The system according to claim 17, wherein the processor further:
analyzes the stored list of items; and
creates a message relating to the analysis of the stored list of items.

22. The system according to claim 21, wherein the message is a suggestion to purchase an item that is not one of the actual scanned items.

23. The system according to claim 21, wherein the message is a promotional offer or coupon for an item that is in the stored list of items.

24. A method of monitoring items comprising:
accessing a stored list of items by a mobile device;
receiving information related to actual items processed at a terminal by the mobile device;
comparing the stored list of items to the actual items by the mobile device;
providing a visual indication of a correspondence or lack of correspondence between the stored list of items and the actual items processed at the terminal by the mobile device.

25. The method according to claim 24, wherein receiving and comparing occur as the items are processed at the terminal.

26. The method of claim 24, wherein the stored list of items comprises coupons.

27. The method of claim 24, wherein the stored list of items comprises products.
